(19) United States
(12) Patent Application Publication
(10) Pub. No.: US 2006/0053070 A1
(43) Pub. Date: Mar. 9, 2006

(54) Parts table management system, parts table preparation method and program

(76) Inventor: Takaaki Kumazawa, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/218,764

(22) Filed: Sep. 6, 2005

(30) Foreign Application Priority Data
Sep. 6, 2004 (JP) 2004-258091

(51) Int. Cl. G06F 17/00

(52) U.S. Cl. 705/28; 707/104.1

(57) ABSTRACT

The system comprises a design information management unit for storing the parts information including each part number to identify a product and a part of the product corresponding to the part number and the quantity of the product and a child part of the part, the subsidiary part information including each subsidiary part number for identifying the subsidiary part and the corresponding subsidiary part number and quantity of the child part of the subsidiary part, and the relating information including each combination of a part number and a part category with the corresponding subsidiary part number. The design information management unit, by specifying the part number and the subsidiary part number corresponding to the part number and the part category for identifying the designated product, prepares a parts table indicating the part number for identifying the designated product, the specified part number and the specified subsidiary part number with the quantity thereof.

### INCORPORATION BY REFERENCE

The present application claims priority from Japanese application JP2004-258091 filed on Sep. 6, 2004, the content of which is hereby incorporated by reference into this application.

### BACKGROUND OF THE INVENTION

This invention relates to a production control technique, or in particular to a technique for managing a parts table indicating a parts configuration of a product.

In manufacturers of electronic and electrical equipment and machine products, a product designer prepares a parts table by selecting parts (design parts) for realizing the functions of the product. The parts described in the parts table, therefore, are built around those required to achieve the functions of the product. The product manufacturing department, on the other hand, needs the materials (auxiliary parts) such as a tape and an adhesive and a packaging material required for manufacture, as well as the design parts required to achieve the product functions. These parts including the auxiliary parts and the packaging material are often selected not by the design department but by the production manager of the manufacturing department. In the manufacturing department, a parts table having a different configuration than the parts table prepared by the designer is often used. In the case where a different department manages a different parts table in this way, the problem is posed that the design department desiring to know the auxiliary parts and the packaging material used in the manufacturing department consumes a considerable time to establish the correspondence with the design parts. Another problem is that an interdepartmental instruction cannot be issued smoothly in case of a design change or the like.

A conventional parts table management technique is known to establish the correspondence between the parts table managed in the design department and the parts acquisition data used by the manufacturing department to procure the parts (for example, JP-A-8-166986). The correspondence established between the parts table managed by the design department and the parts acquisition data used to procure the parts by the manufacturing department facilitates the exchange of the parts data between the design department and the manufacturing department.

In recent years, the environmental problem has become increasingly serious, and each nation has strengthened the restrictions imposed on the manufacturers to reduce the environmental load over the whole life cycle of products. In order to meet these restrictions smoothly, the manufacturers require a system for quantifying the environmental load of each product. In assessing the environmental load of a product, an idea is to use a parts table indicating the parts configuration used for the product.

In evaluating the adaptability of a product to the environmental restrictions, the configuration of the data on the parts to be used is different in accordance with the contents of the required environmental restrictions. Depending on the contents of the environmental restrictions, for example, the chemical substances contained in the adhesive used in the product assembly process and the packaging material of the product are required to be taken into consideration in addition to the design parts making up the product. It is also sometimes necessary to acquire only the data on the quantity of the chemical substances contained in the packaging material of the product.

Patent Document 1 described above discloses the correspondence between the parts table used by the design department and the parts acquisition data used by the manufacturing department to acquire the parts, but fails to consider the evaluation of the product using the parts table. Patent Document 1 also fails to take into consideration the need to prepare a parts table having a different configuration for a different application. An attempt to evaluate the adaptability of a product to the environmental restrictions using the parts table described in Patent Document 1, therefore, often makes it impossible to easily prepare a parts table having a configuration required to evaluate the demanded environmental restrictions.

### SUMMARY OF THE INVENTION

This invention has been achieved in view of this situation, and the object of the invention is to provide a parts table having a data structure in keeping with an intended application.

In order to achieve this object, according to one aspect of the invention, there is provided a parts table management system.

The parts table management system according to this aspect of the invention comprises a parts information storage means for storing the parts information including a part number for identifying a product and a part making up the product in correspondence with the part number for identifying the product and a child part of the part and the quantity thereof; a subsidiary parts information storage means for storing the subsidiary parts information including a subsidiary part number for identifying a subsidiary part with a packaging material of the product and an auxiliary part used for manufacturing the product in correspondence with the subsidiary part number for identifying a child part of the subsidiary part and the quantity thereof; a relating information storage means for receiving the input of the relating information with the corresponding subsidiary part number for each combination of the part number and the part category indicating the type of the part, and storing the received relating information; a means for receiving a parts information preparation request designating the part number and the part category for identifying the product; and a means for specifying the part number and the quantity corresponding to the part number for identifying the designated product using the part number for identifying the product and the parts information stored in the parts information storage means, specifying the subsidiary part number corresponding to the specified part number using the specified part number, the designated part category and the relating information stored in the relating information storage means, specifying the subsidiary part number and the quantity for identifying a child part of the subsidiary part corresponding to the specified subsidiary part number using the specified subsidiary part number and the subsidiary parts information stored in the subsidiary parts information storage means, generating the combined parts information indicating the part number for identifying the designated product, the designated part number and the quantity thereof, and the designated subsidiary part number and the quantity thereof, and outputting the combined parts information thus generated.

As described above, according to this invention, in the case where a parts information preparation request designating the part number and the part category for identifying a product is received, the part number with a quantity and the subsidiary part number with a quantity corresponding to the part number and the part category for identifying the designated product are specified thereby to generate and output the combined parts information indicating the part number for identifying the designated product, the specified part number with the quantity and the specified subsidiary part number with the quantity.

According to this invention, therefore, the parts information having a data structure corresponding to an intended application can be prepared by the user specifying a part category corresponding to the particular intended application.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of a system configuration of a parts table management system according to a first embodiment of the invention.

FIG. 2 is a diagram showing an example of a hardware configuration of a parts table management system according to a first embodiment of the invention.

FIG. 3 is a diagram schematically showing the relation between the parts table information, the subsidiary parts table information and the parts table relating information according to the first embodiment of the invention.

FIG. 4 is a diagram schematically showing an example of the data structure of the parts table information according to the first embodiment of the invention.

FIG. 5 is a diagram schematically showing an example of the data structure of the subsidiary parts table information according to the first embodiment of the invention.

FIG. 6 is a diagram schematically showing an example of the data structure of the parts table relating information according to the first embodiment of the invention.

FIG. 7 is a diagram schematically showing an example of the data structure of the part detail information according to the first embodiment of the invention.

FIG. 8 is a diagram for explaining the flow of the parts table information registration process executed by the parts table management system according to the first embodiment of the invention.

FIG. 9 is a diagram for explaining the flow of the registration process of the subsidiary parts table information and the parts table relating information executed by the parts table management system according to the first embodiment of the invention.

FIGS. 10A, 10B are diagrams showing an example of the setting screen of the parts table relating information displayed by the parts table management system according to the first embodiment of the invention.

FIG. 11 is a diagram for explaining the flow of the parts table preparation process executed by the parts table management system according to the first embodiment of the invention.

FIGS. 12A-12C are diagrams schematically showing the combined parts information according to the first embodiment of the invention.

FIG. 13 is a diagram showing an example of the display screen of the parts table evaluation list displayed by a simulation terminal according to the first embodiment of the invention.

FIG. 14 is a diagram showing an example of the system configuration of the parts table management system according to a second embodiment of the invention.

FIG. 15 is a diagram schematically showing an example of the data structure of the part detail information according to the second embodiment of the invention.

FIG. 16 is a diagram schematically showing an example of the data structure of the evaluation information according to the second embodiment of the invention.

FIG. 17 is a diagram for explaining the flow of the parts table evaluation process executed by the parts table management system according to the second embodiment of the invention.

FIG. 18 is a diagram schematically showing an example of the evaluation list screen displaying the result of evaluating the product-contained chemical substances according to the second embodiment of the invention.

### DETAILED DESCRIPTION OF THE INVENTION

Embodiments of the invention are described below.

### First Embodiment

A first embodiment of the invention is described below.

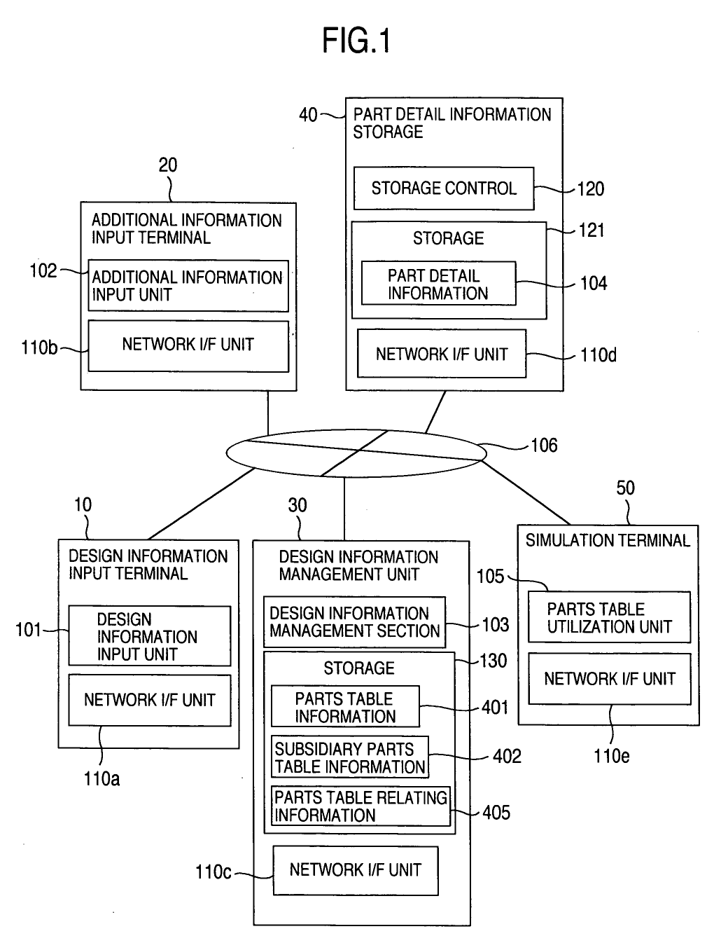

FIG. 1 is a diagram showing an example of the system configuration of a parts table management system according to the first embodiment of the invention.

As shown in FIG. 1, the parts table management system includes a design information input terminal 10, an additional information input terminal 20, a design information management unit 30, a part detail information storage unit 40 and a simulation terminal 50. The design information input terminal 10, the additional information input terminal 20, the design information management unit 30, the part detail information storage unit 40 and the simulation terminal 50 are interconnected through a network 106.

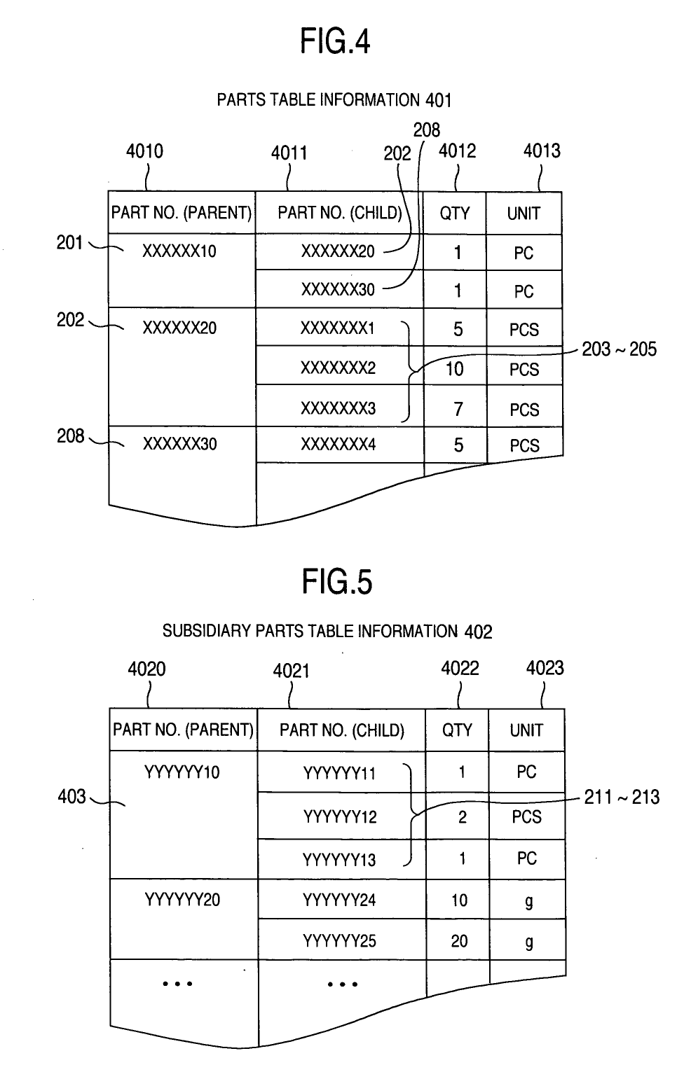

The design information input terminal 10 receives the input of the design part information indicating a product designed by the designer, the part number for identifying a part (design part) making up the product and the quantity of the part. The data structure of the design part information (hereinafter referred to as the “parts table information 401”) is explained in detail later with reference to FIG. 4. Also, the description that follows deals with a case in which the product designer inputs the parts table information 401 to the design information input terminal 10.

Specifically, the design information input terminal 10 includes a design information input unit 101 and a network I/F unit 110a. The design information input terminal 10 is connected to a display unit (not shown) and an input unit (not shown). The network I/F unit 110a controls the data transmitting and receiving operation with the other devices (including the additional information input terminal 20, the design information management unit 30, the part detail information storage unit 40 and the simulation terminal 50) connected to the network 106. The design information input unit 101 displays the input screen on the display unit and receivers the parts table information 401 input through the input unit by the designer. The design information input unit 101 outputs the received parts table information 401 to the design information management unit 30 through the network I/F unit 110a. The hardware configuration of the design information input terminal 10 is described later.

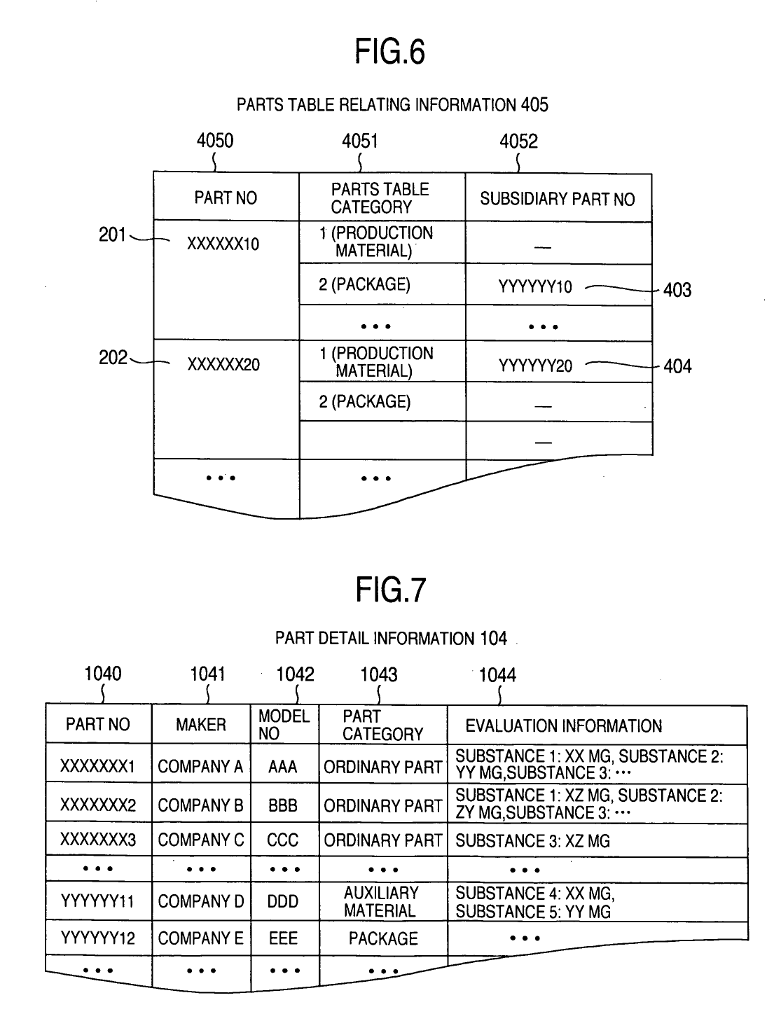

The additional information input terminal 20 receives the input of the information indicating the part number for identifying the production materials and the packaging materials such as an adhesive used in the manufacturing process of the designed product and the quantity thereof. According to this embodiment, the production materials and the packaging materials such as the adhesive and tape used in the product manufacturing process are called “the subsidiary parts”. Also, the information indicating the part number for identifying subsidiary parts and the quantity thereof is called “the subsidiary parts table information 402”. The additional information input terminal 20, after receiving the input of the subsidiary parts table information 402, receives the input of the parts table relating information 405 indicating the correspondence of the design part and the subsidiary part to a predetermined part category (parts table category). The data structure of the subsidiary parts table information 402 and the parts table relating information 405 are described in detail later with reference to FIGS. 5 to 6. Also, the description that follows deals with a case in which the production manager of the manufacturing department inputs the subsidiary parts table information 402 and the parts table relating information 405 to the additional information input terminal 20.

Specifically, the additional information input terminal 20 includes an additional information input unit 102 and a network IF unit 110b. The additional information input terminal 20 is connected with a display unit (not shown) and an input unit (not shown). The network I/F unit 110b controls the data transmitting and receiving operation with the other devices (the design information input terminal 10, the design information management unit 30, the part detail information storage unit 40 and the simulation terminal 50) connected to the network 106. The additional information input unit 102 displays the input screen on the display unit, and receives the subsidiary parts table information 402 and the parts table relating information 405 input by the production manager through the input unit. The additional information input unit 102 outputs the received subsidiary parts table information 402 and the parts table relating information 405 to the design information management nit 30 through the network I/F unit 110a. The hardware configuration of the additional information input terminal 20 is described later.

The design information management unit 30 receives and stores therein the parts table information 401 output from the design information input terminal 10 and the subsidiary parts table information 402 and the parts table relating information 405 output from the additional information input terminal 20. The design information management unit 302 executes the process for preparing the parts table described later, using the parts table information 401, the subsidiary parts table information 402 and the parts table relating information 405 stored therein.

Specifically, the design information management unit 30 includes a design information management section 103, a storage unit 130 for storing the various information and a network I/F unit 110c. The network I/F unit 110c controls the data transmitting and receiving operation with the other devices (including the design information input terminal 10, the additional information input terminal 20, the part detail information storage unit 40 and the simulation terminal 50) connected to the network 106.

The design information management unit 103 receives, through the network I/F unit 110c, the parts table information 401 output from the design information input terminal 10, the subsidiary parts table information 402 and the parts table relating information 405 output from the additional information input terminal 20. The design information management section 103 stores in the storage unit 130 the parts table information 401, the subsidiary parts table information 402 and the parts table relating information 405 received. Further, the design information management section 103 receives a parts table preparation request output from the simulation unit 50 described later. The design information management section 103, upon receipt of the parts table preparation request, produces the information required to prepare the parts table using the parts table information 401, the subsidiary parts table information 402 and the parts table relating information 405 stored therein, and outputs the particular required information to the simulation terminal 50. This process executed by the design information management section 103 is explained in detail later. The hardware configuration of the design information management unit 30 is also described later.

The part detail information storage unit 40 stores the part detail information 104 on the design parts and the subsidiary parts (the data structure of the part detail information 104 is described later). The part detail information storage unit 40 includes a network I/F unit 110d, a storage control unit 120 and a storage unit 121 for storing the part detail information 104. The network I/F unit 110d controls the data transmitting and receiving operation with the other devices (the design information input terminal 10, the additional information input terminal 20, the design information management unit 30 and the simulation terminal 50) connected to the network 106. The storage control unit 121 receives a request to read the part detail information 104 issued from the other devices connected to the network 106. The storage control unit 121, in accordance with the read request thus received, reads the part detail information 104 stored in the storage unit 121 and outputs the part detail information thus read to the requesting device.

The actual configuration of the part detail information storage unit 40 is not specifically limited. The part detail information storage unit 40, for example, can be constituted of a hard disk drive. This embodiment assumes that the part detail information 104 is stored in the part detail information storage unit 40 in advance. The method of storing the part detail information 104 is not specifically limited. For example, the part detail information 104 on the parts supplied by a part supplier through an external network may be stored in the part detail information storage unit 40.

The simulation terminal 50, upon receipt of a parts table preparation request from the designer, presents a parts table meeting the received preparation request. Specifically, the simulation terminal 50 includes a parts table utilization unit 105 and a network I/F unit 110e. The simulation terminal 50 is connected with an input unit (not shown) and a display unit (not shown).

The network I/F unit 110a controls the data transmitting and receiving operation with the other devices (the design information input terminal 10, the additional information input terminal 20, the design information management unit 30 and the part detail information storage unit 40) connected to the network 106. The parts table utilization unit 105, upon receipt of a parts table presentation request from the designer, prepares a parts table corresponding to the received presentation request and displays the prepared parts table on the display unit. This process executed by the parts table utilization unit 105 is explained in detail later. The hardware configuration of the simulation terminal 50 is also explained later.

Next, the hardware configuration of the design information input terminal 10, the additional information input terminal 20, the design information management unit 30 and the simulation terminal 50 is explained.

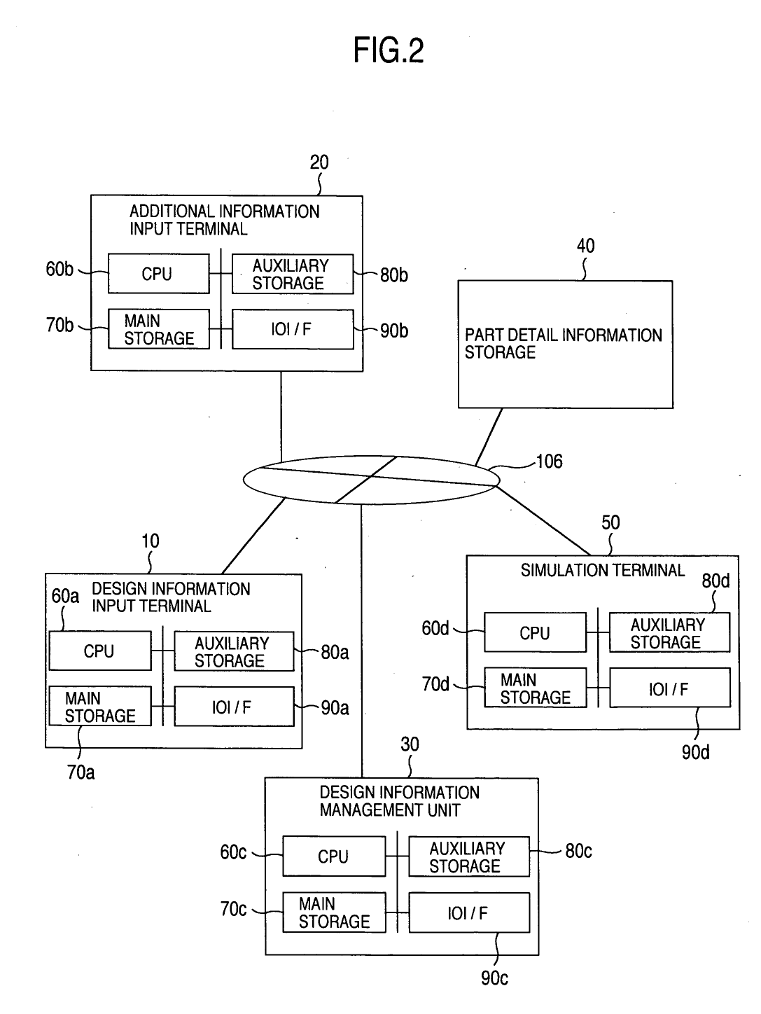

FIG. 2 is a diagram showing an example of the hardware configuration of the parts table management system according to the first embodiment of the invention. The hardware configuration of the part detail information storage unit 40 is already explained.

The design information input terminal 10 may be constituted of a computer system including a CPU (central processing unit) 60a for executing various programs, a main storage unit 70a for temporarily storing the various data and the program executed by the CPU 60a, an auxiliary storage unit 80a such as a hard disk drive to store the program executed by the CPU 60a and an IO I/F 90a for controlling the data transmitting and receiving operation with external devices.

The auxiliary storage unit 80a has stored therein the various programs (the design information input program and the network I/F program) for realizing the functions of the design information input unit 101 and the network I/F unit 110a. The functions of the design information input unit 101 and the network I/F unit 110a are implemented by the CPU 60a executing by loading the aforementioned various programs stored in the auxiliary storage unit 80a onto the main storage unit 70a.

The additional information input terminal 20, like the design information input terminal 10, can be constituted of a computer system including a CPU 60b, a main storage unit 70b, an auxiliary storage unit 80b and an IO I/F 90b. The auxiliary storage unit 80b has stored therein the various programs (the additional information input program and the network I/F program) to implement the functions of the additional information input unit 102 and the network I/F unit 110b. The functions of the design information input unit 101 and the network I/F unit 110b are realized by the CPU 60b executing by loading the aforementioned various programs stored in the auxiliary storage unit 80b onto the main storage unit 70b.

The design information management unit 30, like the design information input terminal 10, can be constituted of a computer system including a CPU 60c, a main storage unit 70c, an auxiliary storage unit 80c and an IO I/F 90c. The auxiliary storage unit 80c has stored therein the various programs (the design information management program and the network I/F program) to implement the functions of the design information management section 103 and the network I/F unit 110c. The functions of the design information management section 103 and the network I/F unit 110c are realized by the CPU 60c executing by loading the aforementioned various programs stored in the auxiliary storage unit 80c onto the main storage unit 70c. The storage unit 130 is arranged in a predetermined area of the auxiliary storage unit 80c.

The simulation terminal 50, like the design information input terminal 10, can be constituted of a computer system including a CPU 60d, a main storage unit 70d, an auxiliary storage unit 80d and an IO I/F 90d. The auxiliary storage unit 80d has stored therein the various programs (the parts table utilization program and the network I/F program) to implement the functions of the parts table utilization unit 105 and the network I/F unit 110e. The functions of the parts table utilization unit 105 and the network I/F unit 110e are realized by the CPU 60d executing by loading the aforementioned various programs stored in the auxiliary storage unit 80d onto the main storage unit 70d.

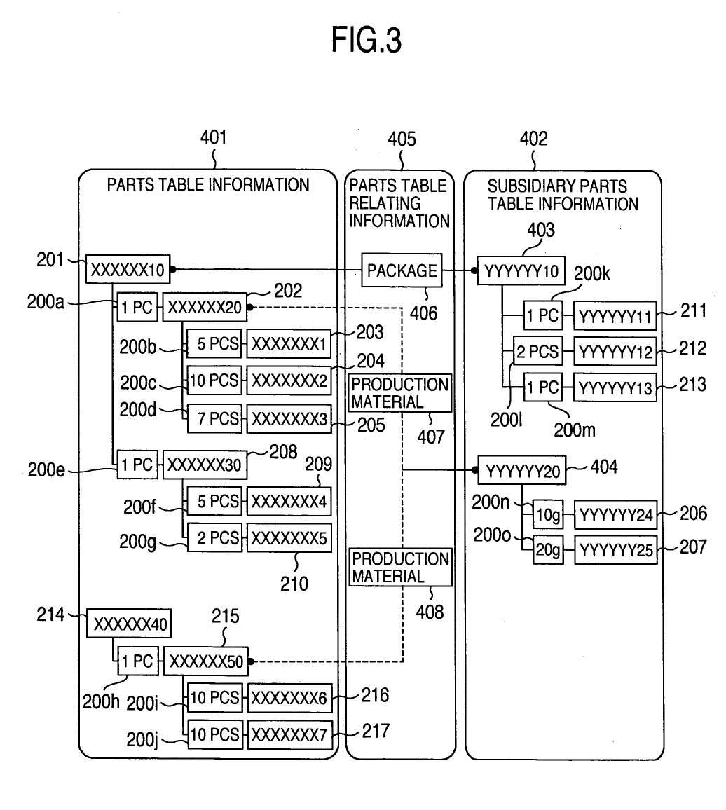

Next, the parts table information 401, the subsidiary parts table information 402 and the parts table relating information 405 stored in the storage unit 130 of the design information management unit 30 according to this embodiment are explained with reference to FIGS. 3 to 6.

First, a general configuration of the parts table information 401, the subsidiary parts table information 402 and the parts table relating information 405 is explained with reference to FIG. 3.

FIG. 3 is a diagram schematically showing the relation between the parts table information 401, the subsidiary parts information 402 and the parts table relating information 405 according to this embodiment.

The parts table information 401 shows the configuration of the design parts registered by the designer in the design information management unit 30 through the design input terminal 10. Reference numerals 201 to 205, 208 to 210 and 214 to 217 designate products or parts. Numerals 200a to 200j on the connecting lines between the products and the parts or between the parts designate the quantity of the parts involved. The product 201, for example, is shown to be configured of one each of the parts 202 and 208. Also, the part 202 is shown to be configured of five parts 203, ten parts 204 and seven parts 205. Similarly, the part 208 is shown to include five parts 209 and two parts 210.

The subsidiary parts table information 402 shows a configuration of the subsidiary parts registered by the production manager in the design information management unit 30 through the additional information input terminal 20. Reference numerals 206 to 207, 211 to 213 and 403 to 404 designate the subsidiary parts. Also, numerals 200k to 200o on the connecting lines between the subsidiary parts indicate the quantity of the subsidiary parts. The subsidiary part 403, for example, is shown to include one subsidiary part 211, two subsidiary parts 212 and one subsidiary part 213.

The parts table relating information 405 is the information whereby the parts table information 401 and the subsidiary parts table information 402 registered in the design information management unit 30 through the additional information input terminal 20 by the production manager are related to each other. Numerals 406 and 408 designate the parts categories. The part categories 406 to 408 are those associated with the parts and subsidiary parts, respectively. The package 406 in the part category, for example, is connected to the product 201 and the subsidiary part 403 by line segments. This indicates that the packaging material used for packaging the product 201 is the subsidiary part 403. Also, the production material 407 in the part category is connected to the part 202 and the subsidiary part 404 by line segments. Similarly, the production material 408 in the part category is connected to the part 215 and the subsidiary part 404 by line segments. This indicates that both the parts 202 and 215 require the subsidiary part 404.

According to this embodiment, in view of the possibility of manufacturing different products under the same conditions the same configuration information of a subsidiary part is used for a plurality of products. In the shown case, the same subsidiary parts 206, 207 of the same quantity are related to the part 205 making up the product 201 and the part 215 making up the product 214. Specifically, once the information that 10 g of the member 206 and 20 g of the member 207 are used is registered in the subsidiary parts table 402, the parts 202 and 215 can share the members 205, 206.

By relating the parts and the subsidiary parts to each other as described above, the required part configuration can be retrieved from the parts table prepared by the designer with reference to the parts table category at the time of evaluating the parts and the component parts of a product. According to this embodiment, therefore, the information indicating the part configuration required for each of various evaluations can be generated.

Next, a specific data structure of the parts table information 401 described above is explained with reference to FIG. 4.

FIG. 4 is a diagram schematically showing an example of the data structure of the parts table information according to this embodiment.

The parts table information 401 describes the correspondence between the parent-child relation of the design parts, quantity and the unit. As shown, the parts table information 401 is configured of a field 4010 for registering the part number to identify the parent parts (product or design part), a field 4011 for registering the part number to identify the child parts underlying each parent part registered in the field 4010, a field 4012 for registering the quantity of the child part registered in the field 4011, and a field 4013 for registering the unit of the quantity registered in the field 4012, all making up one record.

In the shown example, the record with the part number “XXXXXX10” of the product 201 registered in the field 4010 has the corresponding fields 4011 to 4013 having registered therein the part number “XXXXXX20” with the quantity and the unit of the part 202 underlying the product 201, and the part number “XXXXXX30” with the quantity and the unit of the part 208 underlying the part 201.

Then, a specific data structure of the subsidiary parts table information 402 is explained with reference to FIG. 5.

FIG. 5 is a diagram schematically showing an example of the data structure of the subsidiary parts table information according to this embodiment.

The subsidiary parts table information 402 has a similar data structure to the parts table information 401 described above. Specifically, the subsidiary parts table information 402, like the parts table information 401, has a field 4020 for registering the part number to identify the parent part of a subsidiary part, a field 4021 for registering the part number to identify the child part underlying the subsidiary part registered in the field 4020, a field 4022 for registering the quantity of the child part registered in the field 4021, and a field 4013 for registering the unit of the quantity registered in the field 4022, all making up one record.

Next, a specific data structure of the parts table relating information 405 described above is explained with reference to FIG. 6.

FIG. 6 is a diagram schematically showing an example of the data structure of the parts table relating information according to this embodiment.

As shown in FIG. 6, the parts table relating information 405 has a field 4050 for registering the part number, a field 4051 for registering the parts table category, and a field 4052 for registering the part number of the subsidiary part corresponding to the parts table category registered in the field 4051, all making up one record.

Specifically, the field 4050 has registered therein the part number for identifying the product or the design part registered in the field 4010 of the parts table information 401 (FIG. 4). The field 4051 has registered therein the parts table category to make sure that a subsidiary part corresponds to the part number registered in the field 4050. The field 4052 has registered therein the part number for identifying the subsidiary part registered in the field 4020 of the subsidiary parts table information 402 (FIG. 5).

In the shown case, with regard to the record with the part number “XXXXXX10” registered in the field 4050, the “production material” and the “package” are registered as parts table categories in the corresponding field 4051, and the part number “YYYYYY10” of the subsidiary part 403 is registered in the field 4052 corresponding to “package”. This indicates that the design part 201 of part number “XXXXXX10” and the subsidiary part 403 of the subsidiary part number “YYYYYY10” correspond to the parts table category “package”. In the record with the part number “XXXXXX20” registered in the field 4050, on the other hand, the corresponding field 4051 has registered therein the “production material” and the “package” as parts table categories, and “YYYYYY20” indicating the subsidiary part 404 is registered in the field 4052 corresponding to the “production material”. This indicates that the design part 202 of part number “XXXXXX20” and the subsidiary part 404 of the subsidiary part number “YYYYYY20” correspond to the parts table category “production material”.

Next, the data structure of the part detail information 104 stored in the storage section 121 of the part detail information storage unit 40 is explained with reference to FIG. 7.

FIG. 7 is a diagram schematically showing an example of the data structure of the part detail information according to this embodiment. The part detail information 104 has registered therein the detailed information of the parts and the subsidiary parts registered in the parts table information 401 and the subsidiary parts table information 402, respectively.

As shown in FIG. 7, the part detail information 104 has a field 1040 for registering the part number indicating a part and an subsidiary part and fields 1041 to 1044 for registering the “maker name”, “model number”, “part category” and “evaluation information” associated with the part number registered in the field 1040. The “part number” stored in the field 1040 is the one described in FIGS. 4 to 6. Also, the evaluation information stored in the field 1044 is the information to evaluate the part or subsidiary part specified by the part number stored in the field 1040. In the shown case, the evaluation information includes but is not limited to the chemical substance contained in the part and the content thereof. Other evaluation information may be registered in the field 1044. In place of or together with the content of a chemical substance, for example, the cost of each part may be registered in the field 1044.

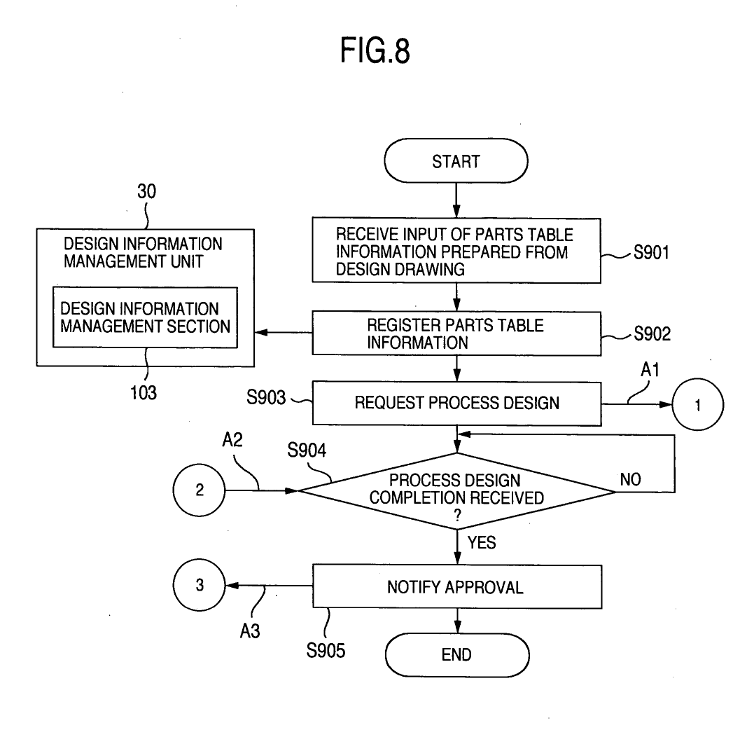

The process for registering the parts table information 401, the subsidiary parts table information 402 and the parts table relating information 405 described with reference to FIGS. 3 to 6 in the design information management unit 30 is explained with reference to FIGS. 8 to 10.

First, the process of registering the parts table information 401 is explained. FIG. 8 is a diagram for explaining the flow of the parts table information registration process executed by the parts table management system according to this embodiment.

First, the design information input unit 101 of the design information input terminal 10 receives the input of the parts table information 401 (FIG. 4) (S901). Specifically, the designer, after preparing the design drawing of a product, selects the design part and the quantity using the design drawing prepared. The information indicating the part number and the quantity of the selected design part is input by the designer to the design information input terminal 10 through the input unit. The information indicating the part number and the quantity of the design part input by the designer also includes the parent-child relation of the parts. The design information input unit 101 receives the parts table information 401 (FIG. 4) indicating the part number and the quantity input through the input unit.

The design information input unit 101 transmits the received parts table information 401 to the design information management section 103 of the design information management unit 30 through the network I/F unit 110a, and requests the registration of the parts table information 401 transmitted (S902). The design information management section 103 of the design information management unit 30 receives, through the network I/F unit 110c, and stores in the storage unit 130 the parts table information 401 transmitted by the design information input unit 101.

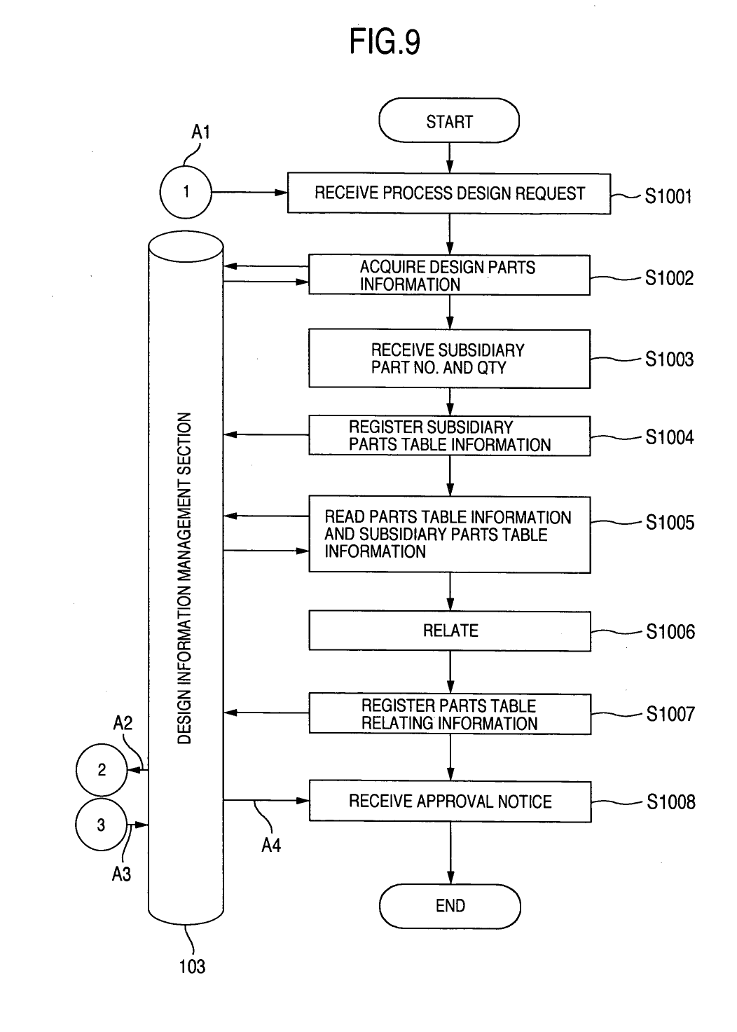

Next, the design information input unit 101 transmits a product process design request notice A1 to the additional information input unit 102 of the additional information input terminal 20, and the process proceeds to step S904 (S903). The additional information input terminal 20, upon receipt of the process design request notice A1, executes the process of receiving the input of the subsidiary parts table information 402 and the parts table relating information. The additional information input terminal 20 transmits the received subsidiary parts table information 402 and the parts table relating information to the design information management unit 30 and requests the registration of the transmitted information (the process executed by the additional information input terminal 20 is explained with reference to FIG. 9). The design information management section 103 of the design information management unit 30 stores in the storage unit 130 the subsidiary parts table information 402 and the parts table relating information 405 transmitted from the additional information input terminal 20, after which the process design completion notice A2 is transmitted to the design information input unit 101.

At step S904, the design information input unit 101 stands by until receipt of the process design completion notice A2 from the design information management section 103, Upon receipt of the process design completion notice A2 by the design information input unit 101 from the design information management section 103, the process proceeds to step S905.

At step S905, the design information management section 103 notifies the design completion to and prompts the designer to confirm the contents of the information (the parts table information 401, the subsidiary parts table information 402 and the parts table relating information) registered in the design information management unit 30. According to this embodiment, the specific method of notifying the design completion to and prompting the designer to confirm the contents thereof is not specifically limited. The design information input unit 101, for example, can display a message on the display unit connected thereto, notifying the design completion to and prompting the designer to confirm the contents of the information registered.

The design information input unit 101, upon receipt of the information indicating the approval of the registered information input by the designer, transmits the information (approval notice) A3 indicating the approval to the design information management section 103 of the design information management unit 30, and the process is ended.

The process executed by the additional information input terminal 20 for registering the subsidiary parts table information 402 and the parts table relating information 405 is explained with reference to FIG. 9. FIG. 9 is a diagram for explaining the flow of the process executed by the parts table management system according to this embodiment to register the subsidiary parts table information and the parts table relating information.

First, the additional information input terminal 20 executes the process of registering the subsidiary parts table information. Specifically, the additional information input unit 102 of the additional information input terminal 20 receives, through the network I/F 10b, the product process design request notice A1 (FIG. 8) transmitted from the design information input terminal 10 (S1001), and the process proceeds to step S1002.

At step S1002, the additional information input unit 102 accesses the design information management section 103 of the design information management unit 30, and acquires the design information (design drawing, etc.) required for the product process design received at step S1101. The design information is assumed to be registered in the storage unit 130 of the design information management unit 30. The design information management section 130, upon receipt of a design information transmit request from the additional information input unit 102, outputs the required design information to the design information input unit 102. The production manager selects the subsidiary parts of the product using the design information, etc. acquired by the additional information input unit 102. The production manager, for example, test produces a product in accordance with the design information, and by quality evaluation, etc., selects the configuration including the type and application amount of an adhesive.

The additional information input unit 102 receives, through the input unit, the input of the part number and the quantity of the subsidiary part selected by the production manager (S1003). The parent-child relation of the subsidiary parts is also set in the subsidiary parts table information 402 (FIG. 5) indicating the part number and the quantity of the subsidiary part input by the production manager.

The additional information input unit 102 transmits, through the network I/F unit 110b, the subsidiary parts table information 402 received at step S1003 to the design information management section 103 of the design information management unit 30, and requests the registration of the subsidiary parts table information 402 transmitted (S1004). The design information management section 103 of the design information management unit 30 receives, through the network I/F unit 110c, the subsidiary parts table information 402 transmitted from the additional information management unit 102, and stores it in the storage unit 130. At this step, the registration of the subsidiary parts table information 402 is completed. After that, the additional information input unit 102 executes the process of registering the parts table relating information 405 as described below.

The additional information input unit 102 acquires the parts table information 401 and the subsidiary parts table information 402 from the design information management section 103 of the design information management unit 30 (S1005), and the process proceeds to step S1006. Specifically, the additional information input unit 102 accesses the design information management section 103 of the design information management unit 30, and requests the transmission of the parts table information 401 and the subsidiary parts table information 402 registered in the storage unit 130 of the design information management unit 30. The design information management section 103, upon receipt of the request, transmits the requested parts table information 401 and the subsidiary parts table information 402 to the additional information input unit 102. The additional information input unit 102 receives the parts table information 401 and the subsidiary parts table information 402 transmitted from the design information management section 103.

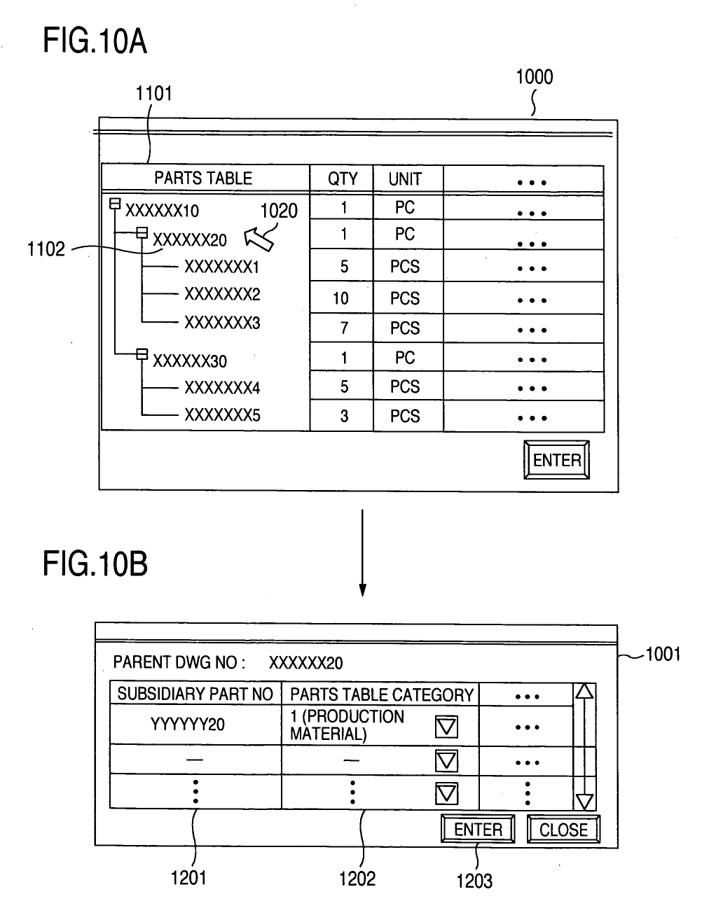

At step S1006, the additional information input unit 102 executes the process of relating a part and an subsidiary part to each other using the parts table information 401 and the subsidiary parts table information 402 acquired. Specifically, the additional information input unit 102 displays on the display unit a setting screen for relating the part in the parts table information 401 and the subsidiary part in the subsidiary parts table information 402 to each other. The additional information input unit 102 receives the information for relating the part and the subsidiary part to each other, input by the production manager in accordance with the setting screen. An example of the setting screen is shown in FIGS. 10A, 10B, which are diagrams showing an example of the setting screen of the parts table relating information displayed by the parts table management system according to this embodiment. FIG. 10A shows a screen 1000 indicating a parts list of the design parts, and FIG. 10B a screen 1001 for relating the parts and the subsidiary parts to each other by the parts table category.

The additional information input unit 102 displays the screen 1000 on the display unit, and receives the selection of the part number of the product or the design part to be related to the subsidiary part. The means for selecting the parts to be related is not specifically limited. For example, the selection of a part number to be related to a subsidiary part can be received by designating, by the cursor 1020 through the input unit, the part number displayed on the screen 1000. The additional information input unit 102, upon receipt of the selection of the part to be related to the subsidiary part, transfers the display screen to the screen 1001 shown in FIG. 10B. The screen 1001 includes an area 1201 for inputting the part number of the subsidiary part to be related to the product or the part designated on the screen 1000 and an area 1202 for inputting the parts table category corresponding to the part number. The information input in the areas 1201, 1202 on the screen are received through the input unit. In the example of the screen shown in FIG. 10B, the part of part number “XXXXXX20” and the subsidiary part of part number “YYYYYY20” are shown to be related to the parts table category “production material”. The additional information input unit 102, upon selection of the enter button 1203 on the screen 1001, receives the information for relating the part and the subsidiary part to each other as the information to be registered in the design information management unit 30.

Returning to FIG. 9, the explanation is continued. The additional information input unit 102 prepares the parts table relating information 405 (FIG. 6) from the information received at step S1006 for relating the part and the subsidiary part to each other. The additional information input unit 102 transmits the parts table relating information 405 thus prepared to the design information management section 103 of the design information management unit 30 through the network I/F unit 110b, and requests the registration of the parts table relating information 405 thus transmitted (S1007). The design information management section 103 receives, through the network I/F unit 110c, and stores in the storage unit 130 the the parts table relating information 405 transmitted from the additional information management unit 102. The design information management section 103, upon storage of the parts table relating information 405 in the storage unit 130, transmits the process design completion notice A2 to the design information input unit 101. Further, the design information management section 103, upon receipt of the approval notice A3 from the design information input unit 101, transmits to the additional information input unit 102 the information (approval notice) A4 indicating the approval of the subsidiary parts table information 402 and the parts table relating information 405 registered.

The additional information input unit 102, upon receipt of the approval notice A4 (S1008), completes the process of registering the subsidiary parts table information 402 and the parts table relating information 405.

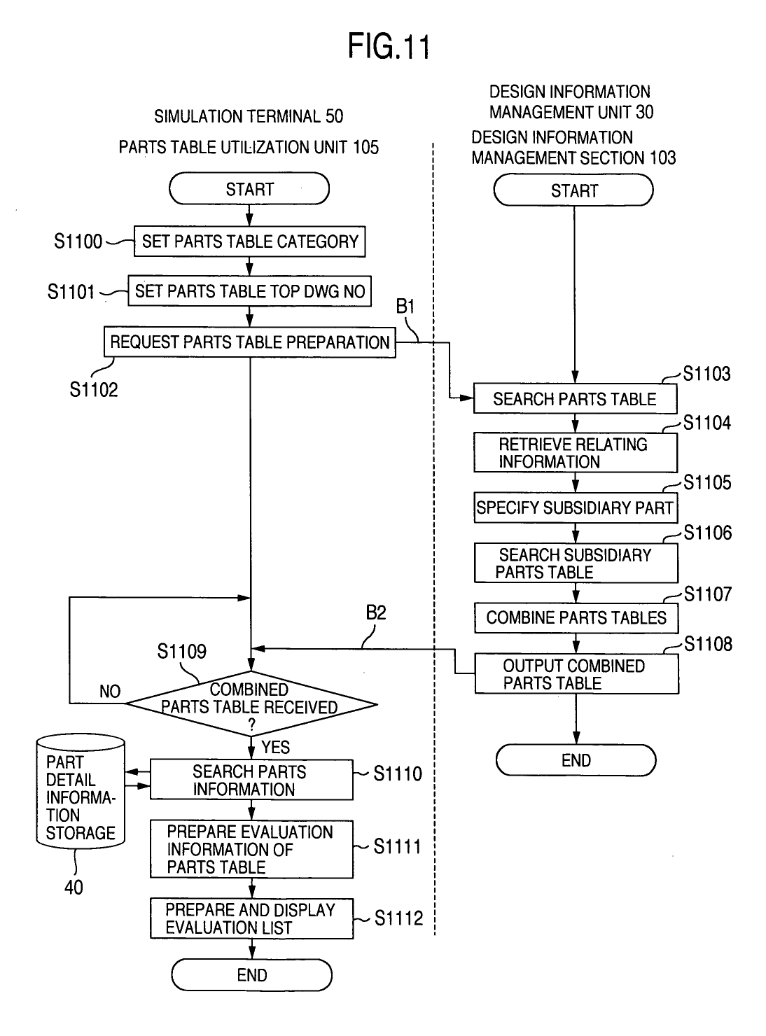

The process of preparing the parts table according to this embodiment is explained with reference to FIG. 11.

FIG. 11 is a diagram for explaining the flow of the parts table preparation process executed by the parts table management system according to this embodiment. Any entity can request the preparation of the parts table, and a case in which the product designer issues a parts table preparation request is described below.

In the parts table preparation process, the first step is for the simulation terminal 50 to receive the parts table preparation request designating the parts table category and the part number input by the designer. The simulation terminal 50 issues the parts table preparation request designating the parts table category and the part number to the design information management unit 30. The design information management unit 30 generates the parts table in accordance with the received parts table preparation request, and transmits the information thus generated to the simulation terminal 50. The simulation terminal 50, upon receipt of the information for preparing the parts table, prepares the parts table using the received information and presents it to the designer. An explanation is made specifically below.

First, a parts table utilization unit 105 of the simulation terminal 50 receives the “parts table category” and the parts table preparation request input by the designer (S1100). In this case, the designer inputs the “parts table category” corresponding to an intended application of the parts table. In the case where the configuration of the production materials of the product is required, for example, the designer inputs the information indicating the “production material” as a parts table category. Also, the designer desirous of knowing the configuration of the product packaging members inputs the “package” as a parts table category.

The parts table utilization unit 105, upon receipt of the setting of the parts table top drawing number (S1101), proceeds to step S1102. The “parts table top drawing” received is the “part number” of the design part not associated with any parent part, i.e. the part number indicating a product. In the case of FIG. 2, for example, the “parts table top drawing” indicates the part number “XXXXXX10” for identifying the product 201 and the part number “XXXXXX40” for identifying the product 214.

At step S1102, the parts table utilization unit 105 issues a parts table preparation request B1 designating the “parts table category” and the “parts table top drawing number” received at steps S1100 and S1101 to the design information management section 103 of the design information management unit 30 (S1102). The parts table utilization unit 105, after issuing the parts table preparation request B1 described above, stands by until the receipt of the combined part information 2 output from the design information management unit 30 described later.

Then, the process executed by the design information management section 103 of the design information management unit 30 is explained.

The design information management section 103, upon receipt of the parts table preparation request output from the parts table utilization unit 105, executes the process described below (S1103 to S1108).

Specifically, the design information management section 103 receives the parts table preparation request B1 designating the “parts table category” and the “parts table top drawing number”. The design information management section 103 searches the parts table information 401 stored in the storage unit 130 and specifies the parts table information corresponding to the “part number” indicated by the “parts table top drawing number” received (S1103).

Assume, for example, that the “pats table top drawing number” received by the design information management section 103 is “XXXXXX10”. In this case, the design information management section 103 retrieves the record with “XXXXXX10” registered in the field 4010 from the parts table information 401 (FIG. 4) stored in the storage unit 130. The design information management section 103 then reads the record with “XXXXXX10 registered in the field 4010. Also, the design information management section 103 specifies the part number registered in the field 4011 of the record thus read out. The design information management section 103 searches the parts table information 401 for the record with the specified part number registered in the field 4010. In the case where the search shows the presence of the record with the specified part number registered in the field 4010, the design information management section 103 reads the particular record.

After that, the design information management section 103 specifies the part number registered in the field 4011 of the record read out, and executes a similar search process. The design information management section 103 continues the search process until the depletion of the record having recorded therein the part number specified in the field 4010.

The design information management section 103 specifies the “part number” registered in the field 4010 of the record of the parts table information read at step S1103. The design information management section 103 retrieves the record having the specified “part number” registered therein, from the parts table relating information stored in the storage unit 130 (S1104). The design information management section 103 then reads the record of the parts table relating information thus retrieved.

Assume, for example, that the record of the parts information read at step S1103 contains “XXXXXX10” and “XXXXXX20”. In this case, the design information management section 103 reads the record with “XXXXXX10” registered in the field 4050, from the parts table relating information 405. Also, the design information management section 103 reads the record with “XXXXXX20” registered in the field 4050, from the parts table relating information 405.

The design information management section 103 specifies the part number of the “subsidiary part” corresponding to the part number and the parts table category using the received “parts table category” and the record of the parts table relating information 405 read at step S1104 (S1105), and then the process proceeds to step S1106. With regard to the “parts table relating information 405” shown in FIG. 6, for example, assume that the “parts table category” received is “package” and the record with “XXXXXX10” registered in the field 4050 is read out at step 1104 (the record registered in the uppermost stage in FIG. 6). In this case, the design information management section 103 specifies the part number “YYYYYY10” of the subsidiary part 403.

At step S1106, as at step S1103, the design information management section 103 searches the subsidiary parts table information 402 stored in the storage unit 130 for the subsidiary parts table information corresponding to the part number of the subsidiary part specified at step S1106, and specifies the subsidiary part information corresponding to the part number of the specified subsidiary part (S1106).

The design information management section 103 executes the parts table combining process for generating the information (combined parts information) to prepare the parts table, using the parts table information 401, the subsidiary parts table information 402 and the parts table relating information 405 that have been read (S1107), and then the process proceeds to step S1108. The “combined parts information” is defined as the correspondence between the configuration of the design parts associated with the received “parts table top drawing number” and the configuration of the subsidiary part.

In the case where the “parts table category” is the “production material” and the “parts table top drawing number” is “XXXXXX10”, for example, the combined part information is defined as the information indicating the configuration of the parts (design parts and subsidiary parts) required for manufacturing the part number “XXXXXX10”. The combined parts information is described below.

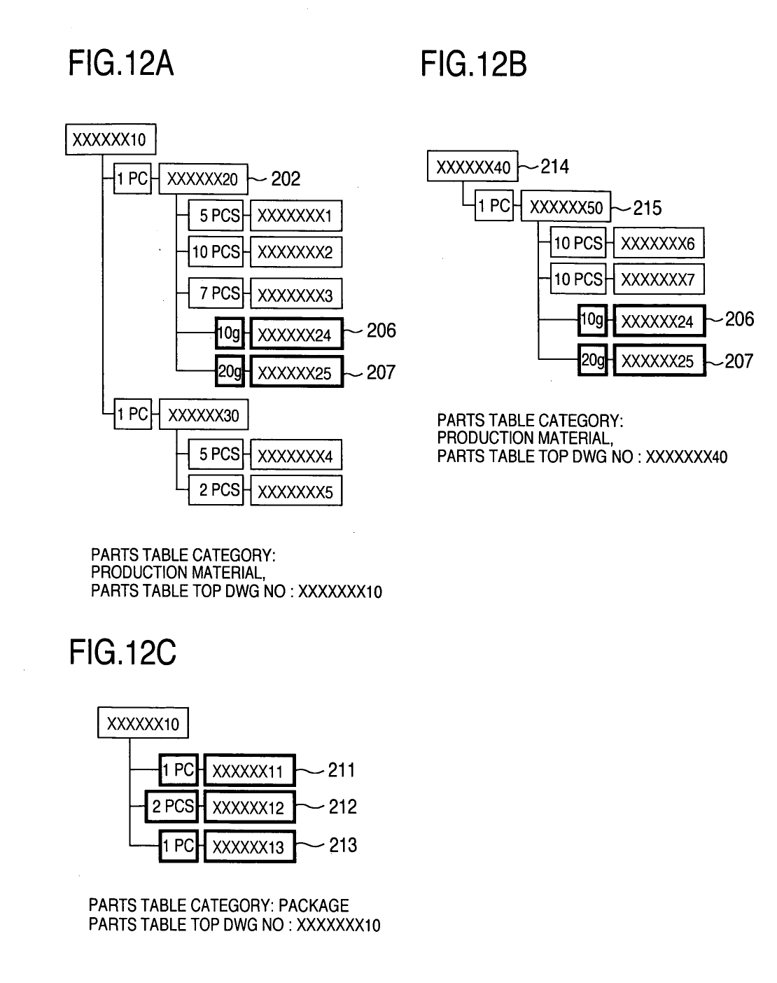

FIGS. 12A, 12B, 12C are diagrams schematically showing the combined parts information according to this embodiment. FIG. 12A shows the combined parts information generated in accordance with the parts table preparation request designating the “production material” as the “parts table category” and “XXXXXX10” as the “parts table top drawing number”. FIG. 12B shows the combined parts information generated in accordance with the parts table preparation request designating the “production material” as the “parts table category” and “XXXXXX40” as the “parts table top drawing number”. In the case where it is desirous to know the amount of the chemical substances contained in the product, for example, all the members contained in the product are required to be taken into consideration. According to this embodiment, therefore, the “parts table category” includes the “production material”, and upon receipt of the designation of the “production material”, the members 206, 207 with the quantity thereof required for manufacture as well as the design part are indicated. In FIGS. 12A, 12B, the part 202 making up the product 201 and the part 215 making up the product 214 indicate that 10 g and 20 g of the members 206, 207, respectively, are used in the manufacturing process.

Also, FIG. 12C shows the combined parts information generated in accordance with the parts table preparation request designating the “package” as the “parts table category” and “XXXXXX10” as the “parts table top drawing number”. In the shown case, the parts not required to know the configuration of the packaging members are not shown.

As described above, according to this embodiment, the designer can prepare the parts table of a configuration meeting an intended application by designating the “parts table category” of the particular application. In the case where the designer is desirous of knowing the parts configuration of the manufacturing parts containing the production materials such as the adhesive and tape, for example, the “production material” is designated as the “parts table category”. Also, the designer desirous of knowing the part configuration of the packaging material used for a product sets the “package” as the “parts table category”.

Returning to FIG. 11, the explanation is continued. At step S1108, the design information management section 103 outputs the combined parts information B2 generated to the parts table utilization unit 105 of the simulation terminal 50. After that, the parts table preparation process is transferred to the process to be executed by the simulation terminal 50. The design information management section 103 ends the parts table preparation process after outputting the combined part information B2.

In the case where the design information management section 103 outputs the combined parts information B2, the parts table utilization unit 105 of the simulation terminal 50 receives the input of the combined parts information B2, and the process proceeds to step S1110 (S1109).

At step S1110, the parts table utilization unit 105 executes the process of retrieving the parts information. The parts information retrieval process is defined as a process to access the part detail information storage unit 40 and acquire the detailed information of the parts and the subsidiary parts contained in the combined parts information B2 received. Specifically, the parts table utilization unit 105 specifies the “part number” indicating the part and the subsidiary part contained in the combined parts information B2 received at step S1109. The parts table utilization unit 105 requests the part detail information storage unit 40 to transmit the detailed information on the part and the subsidiary part identified by the “part number” specified. The part detail information storage unit 40 reads the requested detailed information on the requested part and the subsidiary part from the part detail information 104, and outputs the detailed information of the particular part to the parts table utilization unit 105. The parts table utilization unit 105 receives the detailed information of the part and the subsidiary part output from the part detail information storage unit 40.

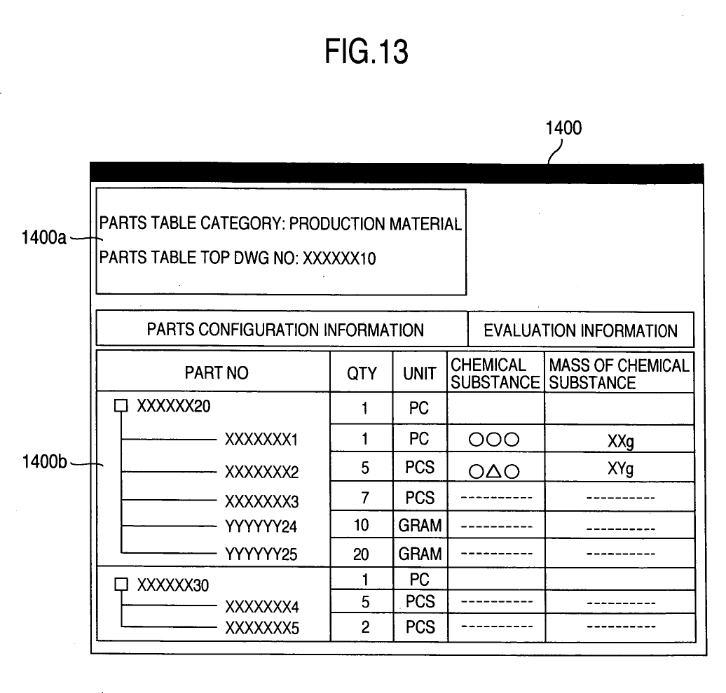

The parts table utilization unit 105 prepares the parts table evaluation information including the evaluation information of a part corresponding to the configuration information of the particular part using the detailed information on the part and the subsidiary part acquired at step S1110 and the combined part information B2 acquired at step S1109 (S1111). The parts table utilization unit 105 prepares an evaluation list using the parts table evaluation information prepared at step S1111, and outputs the evaluation list thus prepared to the display screen of the display unit (S1112). The parts table utilization unit 105 displays, for example, the parts table evaluation list screen shown in FIG. 13 on the display unit.

FIG. 13 is a diagram showing an example of the display screen of the parts table evaluation list displayed by the simulation terminal 50 according to this embodiment.

The display screen 1400 includes an area 1400a for displaying the “parts table category” and the “parts table top drawing number” received from the designer, and a parts table evaluation information display area 1400b for displaying the parts table evaluation list with the evaluation information corresponding to the part configuration information shown in the combined parts table information. Thus, the display screen 1400 displays the amount of the chemical substances contained in each component part as a parts table evaluation list. From the display screen 1400 shown, the designer can check the configuration of the design part and the subsidiary part required for manufacturing the product “XXXXXX10”, and also the amount of the chemical substances contained in the product “XXXXXX10” at the same time.

As described above, according to this embodiment, the parts table meeting the intended application can be prepared by setting the “parts table category” and the “parts table top drawing number” corresponding to the intended application of the parts table. Also, the parts table prepared by the parts table management system according to this embodiment contains the correspondence of the evaluation information of the parts and the subsidiary parts. According to this embodiment, therefore, the part configuration can be easily evaluated for each intended application.

### Second Embodiment

A second embodiment of the invention is explained below.

The second embodiment is a modification of the function of the parts table preparation process according to the first embodiment, and intended to evaluate the parts table after considering various restrictions. The description that follows deals with a case in which the second embodiment is used for evaluation of the environmental restrictions against the amount of the chemical substances contained in a product. In the description of the second embodiment, the same component parts as those of the first embodiment are designated by the same reference numerals, respectively.

First, a system configuration according to the second embodiment of the invention is explained.

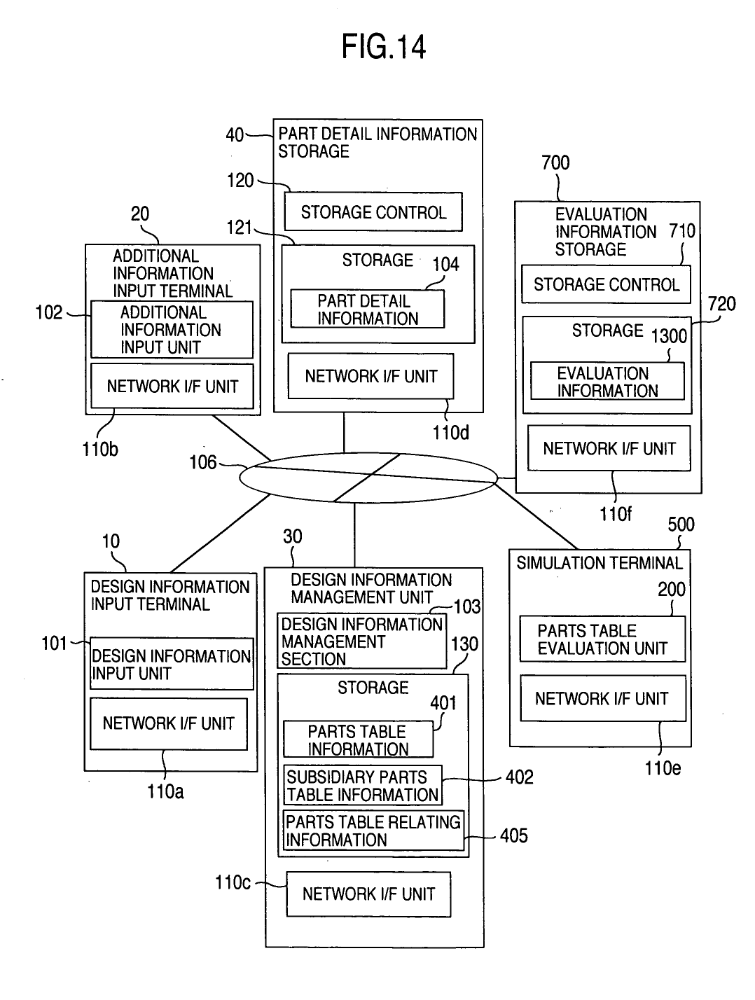

FIG. 14 is a diagram showing an example of the system configuration of the parts table management system according to the second embodiment of the invention.

The parts table management system according to the second embodiment is similar in configuration to the first embodiment except that the function of the simulation terminal are different from that of the first embodiment, an evaluation information storage unit 700 is included and the part detail information 104 stored in the part detail information storage unit 40 has a different data structure. Specifically, the parts table management system according to the second embodiment comprises a design information input terminal 10, an additional information input terminal 20, a design information management unit 30, a part detail information storage unit 40, a simulation terminal 500 and an evaluation information storage unit 700. The description that follows is concentrated on the parts different from those of the first embodiment.

The simulation terminal 500 includes a parts table evaluation unit 200 and a network I/F unit 110e. The network I/F unit 110e is identical with the corresponding one used in the first embodiment. The parts table evaluation unit 200 has the function of evaluating the parts table considering the restrictions in addition to the function of the parts table utilization unit 105 according to the first embodiment. The hardware configuration of the simulation terminal 500 is identical with that of the simulation terminal 50 (FIG. 2) according to the first embodiment. The auxiliary storage unit 80d of the simulation terminal 500 has stored therein various programs (the parts table evaluation program and the network I/F program) for realizing the functions of the parts table evaluation unit 200 and the network I/F unit 110e described above. The function of the simulation terminal 500 is realized by the CPU 60 executing by loading each program stored in the auxiliary storage unit 80d onto the main storage unit 70d.

The evaluation information storage unit 700 is for storing the evaluation information 1300 to evaluate the parts (the data structure of the evaluation information is described later). The evaluation information storage unit 700 includes a network I/F unit 110f, a storage control unit 710 and a storage unit 720 for storing the evaluation information 1300. The network I/F unit 110f controls the data transmitting and receiving operation with the other devices connected to the network 106. The storage control unit 710 receives the request from the other devices connected to the network 106 to read the evaluation information 1300. The storage control unit 710, in response to the received read request, reads the evaluation information 1300 stored in the storage unit 720 and outputs it to the device requesting the evaluation information 1300 that has been read. The evaluation information storage unit 700 may be constituted of, for example, a hard disk drive. According to this embodiment, the evaluation information 1300 is stored beforehand in the evaluation information storage unit 700.

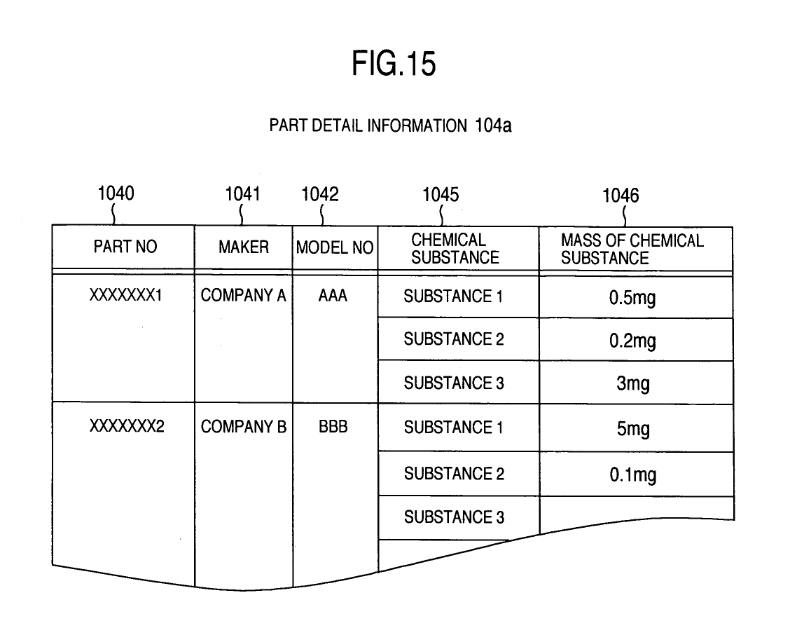

Next, the data structure of the part detail information stored in the part detail information storage unit 40 according to the second embodiment is explained with reference to FIG. 15.

FIG. 15 is a diagram schematically showing an example of the data structure of the part detail information according to the second embodiment. The part detail information 104a, like in the first embodiment illustrated in FIG. 7, has registered therein the detailed information on the parts and the subsidiary parts registered in the parts table information 401 and the subsidiary parts table information 402.

As shown in FIG. 15, the part detail information 104 includes a field 1040 for registering the part number indicating a part and an subsidiary part, a “maker” of the part identified by the part number registered in the field 1040, fields 1041 to 1042 for registering the “model number”, and fields 1045 to 1046 for registering the “name of the chemical substance” and the “amount of the chemical substance” contained in the part identified by the part number registered in the field 1040. In the shown case, the chemical substance contained in the part and the content amount thereof are indicated as the evaluation information, to which the invention is not specifically limited. Instead, the other information may alternatively be stored in the fields 1045 to 1046.

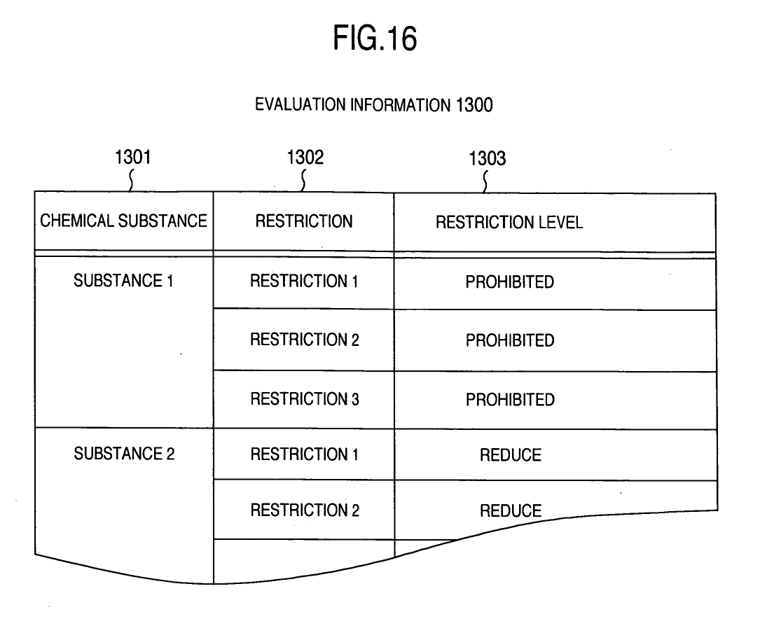

Next, the data structure of the evaluation information 1300 stored in the evaluation information storage unit 700 is explained with reference to FIG. 16.

FIG. 16 is a diagram schematically showing an example of the data structure of the evaluation information.

As shown in FIG. 16, the evaluation information 1300 includes a field 1301 for registering the “name of the chemical substance”, a field 1302 for registering the “restriction name” indicating the name of restriction applicable to the chemical substance shown by the “name of the chemical substance” registered in the field 1301, and a field 1303 for registering the “restriction level” indicating the contents of the “restriction name” registered in the field 1302, all making up a single record. The aforementioned restriction includes voluntary restrictions laid down by the makers and the industry as well as the restrictions stipulated by laws and government ordinances.

In the shown example, three restriction names including “restriction 1”, “restriction 2” and restriction 3” are registered in the field 1302 of the record with the “substance 1” registered in the field 1301 thereof. The “prohibition” is registered in each field 1303 corresponding to the “restriction name”. The “substance 1” indicates that the three restrictions are applicable and the contents of the three restrictions are “prohibited from use”.

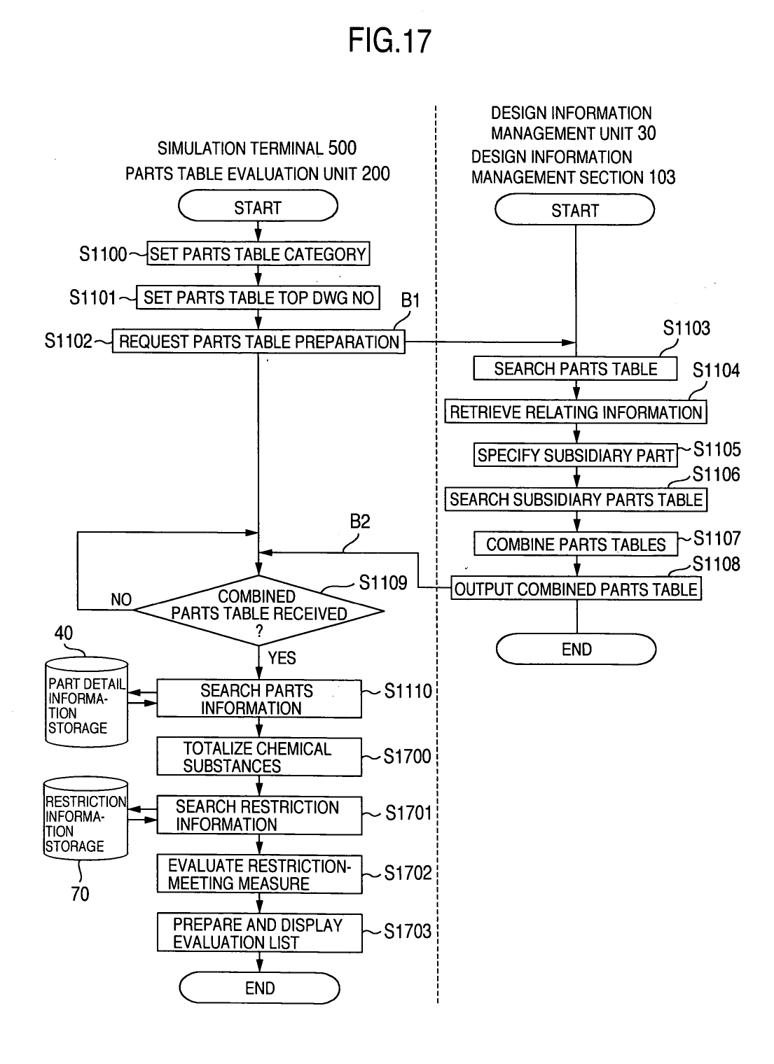

Next, the process of evaluating the parts table according to the second embodiment is explained with reference to FIG. 17.

FIG. 17 is a diagram for explaining the flow of the parts table evaluation process executed by the parts table management system according to the second embodiment.

First, the parts table evaluation unit 200 of the simulation terminal 500 executes a similar process to steps S1100 to S1102 shown in FIG. 11. Specifically, the parts table evaluation unit 200 of the simulation terminal 500 receives the “parts table category” and the “parts table top drawing number” input by the designer. The parts table evaluation unit 200 gives a parts table preparation request B1 designating the “parts table category” and the “parts table top drawing number” received by the design information management section 103 of the design information management unit 30 to the design information management section 103 of the design information management unit 30.

The design information management section 103 of the design information management unit 30, upon receipt of the parts table preparation request B1 output from the parts table evaluation unit 200, executes a similar process to steps S1103 to 1108 shown in FIG. 11. After that, the parts table evaluation process transfers to the process executed by the simulation terminal 500. The process executed by the design information management section 103 is already explained and not explained below.

The parts table evaluation unit 200 of the simulation terminal 500, upon the output of the combined parts information B2 from the design information management section 103, executes a similar process to steps S1109 to S1110 shown in FIG. 11, after which the process proceeds to step S1700.

At step S1700, the parts table evaluation unit 200, using the detailed information of the parts acquired from the part detail information storage unit 40 at step S1100 and the combined parts information B2 acquired at step S1109, totalizes the content amount of the chemical substances contained in the parts (design parts and subsidiary parts) corresponding to the “parts table top drawing number” input by the designer.

Then, the parts table evaluation unit 200 executes the restriction information retrieval process (S1701). Specifically, the parts table evaluation unit 200 specifies the name of the chemical substance totalized at step S1700. The parts table evaluation unit 200 requests the evaluation information storage unit 700 to transmit the detailed information of the chemical substance indicated by the specified “name of the chemical substance”. The evaluation information storage unit 700 reads the requested detailed information of the “chemical substance” from the evaluation information 1300, and outputs the evaluation information of the chemical substance to the part evaluation unit 200. The part evaluation unit 200 receives the evaluation information of the chemical substance output from the evaluation information storage unit 700.

After that, the parts table evaluation unit 200 executes the restriction-meeting measure evaluation process (S1702). The restriction-meeting measure evaluation process is to generate the restriction-meeting measure evaluation information to secure the correspondence of the evaluation information between the chemical substance totalized at step S1700 and the chemical substance received at step S1701. Specifically, the parts table evaluation unit 200, using the evaluation information of the chemical substance totalized at step S1701 and the chemical substance received at step S1701, generates the restriction-meeting measure evaluation information including the correspondence of the amount of the chemical substance totalized for each restriction level.

The parts table evaluation unit 200 prepares the evaluation list using the restriction-meeting measure evaluation information generated at step S1702, and outputs the evaluation list thus prepared to the display screen of the display unit (S1703).

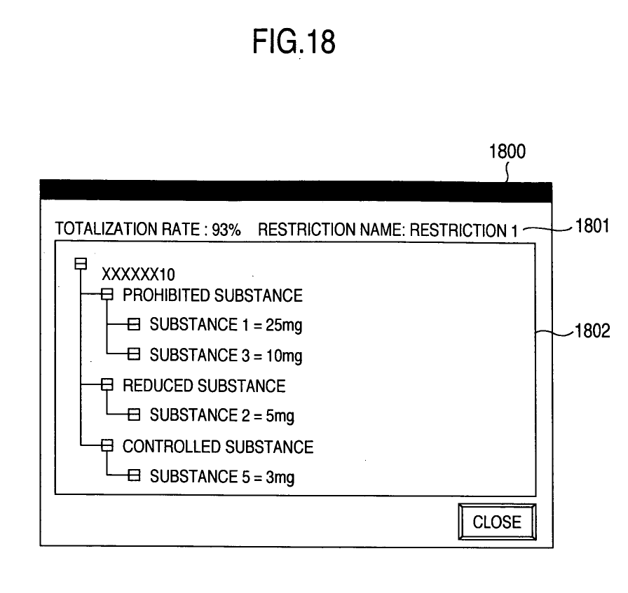

Next, the evaluation list output to the display screen by the parts table evaluation unit 200 is explained with reference to FIG. 18.

FIG. 18 is a schematic diagram for explaining an example of the evaluation list screen showing the evaluation result of the chemical substance contained in the product according to the second embodiment.

As shown in FIG. 18, the screen 1800 includes an area 1801 for displaying the “restriction name” and an area 1802 for displaying the contents of the chemical substance totalized for each restriction level. The screen 1800 classifies the chemical substances by level of “restriction 1”, and displays the result of totalization of the contents of each chemical substance contained in the product. The designer, by watching the screen 1800 and determining the presence or absence and the amount of the prohibited substance, can study the design improvement.

As described above, according to the second embodiment, not only the design parts making up the product but also the chemical substances of the product including the adhesive and the packaging materials can be automatically totalized, and therefore a highly accurate totalization result is secured quickly, thereby making it possible to take an appropriate measure for environmental control.

This invention is not limited to the embodiments described above, and can be variously modified without departing from the spirit and scope thereof. In the first embodiment described above, for example, the functions of the various parts implemented by a plurality of devices (the design information input unit 101, the additional information input unit 102, the design information management section 103, the parts table utilization unit 105, the network I/F unit 110, the storage unit 130, the storage unit 121 and the storage control unit 120) can be realized by a single computer. Similarly, in the second embodiment, the functions of the various parts can be implemented by a single computer. In such a case, a single program may be used to execute the various functions.

Also, the parts table utilization unit 105 (or the parts table evaluation unit 200), in addition to the function of receiving the setting of a parts table category, can have the function of selecting the “evaluation information” of the part detail information 104 in accordance with the parts table category received. In this case, the part detail information 104 holds a plurality of types of evaluation information (the part attribute information). The parts table utilization unit 105 (or the parts table evaluation unit 200) prepares the evaluation list of the parts table using the “evaluation information” selected in accordance with the parts table category, and displays the particular evaluation list. This is the result of taking into consideration the fact that even though the required parts configuration is the same for various evaluations, the attribute data of the parts for evaluation may be different. The “evaluation of the amount of the chemical substance contained in the product”, for example, requires the “amount of the chemical substance contained in the product”, and the LCA (life cycle assessment; the evaluation of the environmental load of the “product”) requires the amount of CO₂ emission to manufacture the “part”.

By employing this configuration, therefore, the information required for product evaluation can be managed on the basis of a single principle, with the result that the number of steps of collecting and managing the information can be reduced. Also, the aforementioned configuration makes it possible to carry out various evaluations without constructing a complicated system.

Also, in addition to the function of receiving the setting of the parts table category, the parts table utilization unit 105 (or the parts table evaluation unit 200) may have the function of selecting the “quantity” information of the parts table 401 in accordance with the received parts table category.

Also, the simulation terminal 50 (or 500) may hold the information indicating the correspondence between an intended application of the parts table and the parts table category in advance. For example, the “production material” is described as the parts table category corresponding to the “application of the packaging material for environmental evaluation”. By doing so, the designer can evaluate the part configuration meeting the intended application simply by setting the “intended application”. Further, the “design part”, “subsidiary part”, “packaging material” and the “production material (adhesive, tape, etc.)” may be set as an intended application. In the case where the simulation terminal 50 receives the selection of the “design part” or the “subsidiary part” as an intended application, the design information management unit 30 prepares only the parts configuration information of the corresponding design part or subsidiary part and outputs them to the simulation terminal 50 without the part combining process. By doing so, the simulation terminal according to this embodiment can satisfy the desire of evaluation of only the design parts or the subsidiary parts.

Also, the parts table evaluation unit 200 may have the function to receive the “contents of restriction”, so that only the “contents of restriction” received by the part evaluation unit 200 may be evaluated.

It should be further understood by those skilled in the art that although the foregoing description has been made on embodiments of the invention, the invention is not limited thereto and various changes and modifications may be made without departing from the spirit of the invention and the scope of the appended claims.

1. A parts table management system for managing a parts table indicating the parts configuration of a product, comprising:
a parts information storage means for storing the parts information including a part number for identifying a product and a part making up the product in correspondence with the part number for identifying the product and a child part of the part and the quantity thereof;
a subsidiary parts information storage means for storing the subsidiary parts information including a subsidiary part number for identifying a subsidiary part with a packaging material of the product and an auxiliary part used for manufacturing the product in correspondence with the subsidiary part number for identifying the child part of the subsidiary part and the quantity thereof;
a relating information storage means for receiving the input of the relating information with the corresponding subsidiary part number for each combination of the part number and the part category indicating the type of the part, and storing the received relating information;
a means for receiving a parts information preparation request designating the part number and the part category for identifying the product; and
a means for specifying the part number and the quantity corresponding to the part number for identifying the designated product using the part number for identifying the product and the parts information stored in the parts information storage means, specifying the subsidiary part number corresponding to the specified part number using the specified part number, the designated part category and the relating information stored in the relating information storage means, specifying the subsidiary part number and the quantity for identifying a child part of the subsidiary part corresponding to the specified subsidiary part number using the specified subsidiary part number and the subsidiary parts information stored in the subsidiary parts information storage means, generating the combined parts information indicating the part number for identifying the designated product, the designated part number and the quantity thereof, and the designated subsidiary part number and the quantity thereof, and outputting the combined parts information thus generated.

2. A parts table management system according to claim 1, further comprising:
a means for storing the part evaluation information including each part number and the corresponding information for evaluating the part, and the subsidiary part evaluation information including each subsidiary part number and the corresponding information for evaluating the subsidiary part; and
a means for preparing a parts table indicating the part number for identifying the designated product, the part evaluation information for the specified part number and the quantity thereof, and the subsidiary part evaluation information for the specified subsidiary part number and the quantity thereof, using the combined parts information, the part evaluation information and the subsidiary part evaluation information.

3. A parts table management system according to claim 2,
wherein the information for evaluating the part corresponding to the part evaluation information includes the name and mass of each chemical substance contained in the part identified by the part number; and
wherein the information for evaluating the subsidiary part corresponding to the subsidiary part evaluation information includes the name and mass of each chemical substance contained in the subsidiary part identified by the subsidiary part number.

4. A parts table management system according to claim 3, further comprising:
a means for storing the restriction information including the corresponding type and contents of restriction applicable to the chemical substance;
wherein the means for preparing the parts table includes
a means for calculating the mass of each chemical substance contained in the specified part number and the specified subsidiary part number, using the combined parts information, the part evaluation information and the subsidiary part evaluation information, and
a means for preparing the parts table evaluation information indicating the name and mass of the chemical substance subjected to each type of restriction, using the calculated quantity of each chemical substance and the restriction information.

5. A parts table management system according to claim 2,
wherein the part evaluation information indicates the cost of the part identified by the part number, and
wherein the subsidiary part evaluation information indicates the cost of the subsidiary part identified by the subsidiary part number.

6. A parts table preparation method executed by a parts table management system having a storage unit for managing the parts table indicating the configuration of a product, comprising the steps of:
receiving, for each part number to identify a product and each part making up the product, the input of the part information including the corresponding part number, with the quantity thereof, for identifying the product and a child part of the part, and storing the received part information in the storage unit;
receiving, for each subsidiary part number to identify a subsidiary part including a packaging material of the product and an auxiliary part used for manufacturing the product, the input of the subsidiary part information with the corresponding subsidiary part number, with the quantity thereof, for identifying the child part of the subsidiary part, and storing the received subsidiary part information in the storage unit;
receiving the input of the relating information with the corresponding subsidiary part number for each combination of the part number and the part category indicating the type of the part, and storing the received relating information in the storage unit;
receiving a part information preparation request designating the part number and the part category for identifying the product;
specifying the part number and the quantity thereof corresponding to the part number for identifying the designated product using the part number for identifying the designated product and the part information stored in the storage unit;
specifying the subsidiary part number corresponding to the specified part number and the specified part category using the specified part number, the designated part category and the relating information stored in the storage unit;
specifying the subsidiary part number, with the quantity thereof, for identifying a child part of the subsidiary part corresponding to the specified subsidiary part number using the specified subsidiary part number and the subsidiary part information stored in the storage unit; and
generating the combined part information indicating the part number for identifying the designated product, the specified part number and the quantity thereof, and the specified subsidiary part number and the quantity thereof, and outputting the combined part information thus generated.

7. A program for causing a computer having a storage unit to execute the process of preparing a parts table indicating the parts configuration of a product, the program comprising the steps of:
receiving, for each part number to identify a product and each part making up the product, the input of the part information including the corresponding part number, with the quantity thereof, for identifying the product and a child part of the part, and storing the received part information in the storage unit;
receiving, for each subsidiary part number to identify a subsidiary part including a packaging material of the product and an auxiliary part used for manufacturing the product, the input of the subsidiary part information with the corresponding subsidiary part number, with the quantity thereof, for identifying the child part of the subsidiary part, and storing the received subsidiary part information in the storage unit;
receiving the input of the relating information with the corresponding subsidiary part number for each combination of the part number and the part category indicating the type of the part, and storing the received relating information in the storage unit;
receiving a part information preparation request designating the part number and the part category for identifying the product;
specifying the part number and the quantity thereof corresponding to the part number for identifying the designated product using the part number for identifying the designated product and the part information stored in the storage unit;
specifying the subsidiary part number corresponding to the specified part number and the specified part category using the specified part number, the designated part category and the relating information stored in the storage unit;
specifying the subsidiary part number, with the quantity thereof, for identifying a child part of the subsidiary part corresponding to the specified subsidiary part number using the specified subsidiary part number and the subsidiary part information stored in the storage unit; and
generating the combined part information indicating the part number for identifying the designated product, the specified part number and the quantity thereof, and the specified subsidiary part number and the quantity thereof, and outputting the combined part information thus generated.
